(19) United States
(12) Patent Application Publication
(10) Pub. No.: US 2025/0001822 A1
(43) Pub. Date: Jan. 2, 2025

(54) COUPLING ROD AND METHOD FOR PRODUCING SAME

(71) Applicant: Muhr und Bender KG, Attendorn (DE)

(72) Inventors: ARNE BUSCH, Burbach (DE); EDUARDO GONZÁLEZ PÉREZ, Amorebieta (ES); CHRISTIAN FRIEDRICH, Limburg (DE)

(21) Appl. No.: 18/709,892

(22) PCT Filed: Nov. 24, 2022
(86) PCT No.: PCT/EP2022/083097

§ 371 Date: May 14, 2024

(30) Foreign Application Priority Data
Nov. 25, 2021 (DE) 10 2021 130 919.0

(51) Int. Cl. B60G 7/00; B29C 45/14; B29C 70/20; B29C 70/52; B29C 70/54; B29L 31/06; B60G 21/055; F16C 7/02

(52) U.S. Cl. CPC B60G 7/001; B29C 45/14467; B29C 70/20; B29C 70/52; B29C 70/545; F16C 7/026; B29K 2995/0046; B29K 2995/007; B29K 2995/0077; B29K 2995/0097; B29L 2031/06; B60G 21/0551; B60G 2204/416; B60G 2206/012; B60G 2206/7101; B60G 2206/8105; B60G 2206/8106

(57) ABSTRACT

A coupling rod comprises a connecting element made of a fiber-reinforced plastic by a pultrusion process, the connecting element having a strut portion with a longitudinal axis and a connecting portion; a joint element; and a carrier element connected to the connecting element and the joint element, the carrier element being made of plastic by overmolding; wherein the matrix of the fiber-reinforced plastic is a thermoset and the connecting portion is formed relative to the strut portion, wherein an interlocking connection is formed between the connecting portion and the carrier element by the overmolded carrier element. A method of producing a coupling rod is further described.

### CROSS-REFERENCE TO RELATED APPLICATIONS

This application is a national stage of, and claims priority to, Patent Cooperation Treaty Application No. PCT/EP2022/083097, filed on Nov. 24, 2022, which application claims priority to German Application No. DE 10 2021 130 919.0, filed on Nov. 25, 2021, which applications are hereby incorporated herein by reference in their entireties.

### BACKGROUND

A coupling rod is used to connect the stabilizer bar to the chassis of a vehicle. The upward and downward movements of a wheel that occur while driving are transmitted to the stabilizer bar via the coupling rods. If the forces between the wheels of an axle are different, the stabilizer bar is loaded. This reduces vehicle roll when cornering and increases driving stability.

Coupling rods can have ball joints at their ends, via which they are connected to the chassis and/or stabilizer bar. Coupling rods are also known as sway bars, stabilizer struts, torsion bars or axle struts.

A coupling rod is known for example from FR 2 862 559 A1, the connecting rod of which is made of fiber-reinforced plastic by pultrusion. The ends are molded to the connecting rod with the joints. The profile that forms the rod can be made from a thermoplastic or thermosetting rigid polymer material or aluminum. The connecting rod has a uniform cross-section along its length.

A stabilizer for a motor vehicle suspension is known from EP 3 385 097 A1. The stabilizer comprises a tubular body which has two flattened areas at each of its ends, between which a sealed cavity is formed, and a sheathing body made of polymeric material which is joined to the respective end of the tubular body in the forming process so that it surrounds the flattened areas. The end-side sheathing bodies each have a joint connection. The tubular body is preferably made of metal, but can also be made of a thermoplastic material.

An axle strut for a vehicle is known from DE 10 2017 207 164 A1, corresponding to WO 2018/197136 A1, which has a carrier profile and two load-introducing elements connected thereto by adhesive bonding. The carrier profile is formed from continuous fiber-reinforced plastic and is produced continuously by means of a pultrusion process or by means of a pull-winding process.

From DE 10 2018 213 322 A1, a multi-point control arm for a motor vehicle chassis is known, which has a pultruded hollow profile portion made of a fiber-reinforced plastic.

From DE 10 2005 034 210 A1, a method for manufacturing a ball joint for a coupling rod is known.

From EP 3 283 279 B1, a pultrusion device for producing a fiber-reinforced continuous profile with a discontinuous cross-sectional profile in the pultrusion direction is known, as well as a method for producing same.

From DE 10 2019 218 124 B3, a method for connecting a hollow body made of fiber-reinforced plastic to a metal body in a form-locking manner. The hollow body is placed in a die-casting mold, into which a molten metal is then introduced under pressure. The pressure of the molten metal is greater than the pressure in the interior of the hollow body, so that the wall of the hollow body is partially pressed into a connecting portion due to the pressure difference, forming a depression. Molten metal penetrates into the cavity, which then solidifies and forms the metal body in the solidified state.

From DE 10 2010 041 791 A1, a stabilizer with a joint receptacle is known that has an end area with a recess in which a connecting element engages in a form-fitting manner. The source material of the connecting element can consist of metal and/or fiber-reinforced plastic.

From DE 10 2013 007 284 A1, a connecting strut is known with a rod portion and bearing eyes at the ends. The connecting strut consists at least partially of fiber-reinforced plastic, which is formed by prepregs.

From DE 10 2014 220 796 A1, a connecting rod for a motor vehicle, with a connecting rod designed as an open profile and two joints connected to each other via this. The joints each comprise a joint housing in which the connecting rod is embedded with its axial ends.

From EP 1 953 012 A2, an articulated rod for vehicles is known with a strut body to each end of which a joint is connected. The strut body is formed from an open profile and the joint comprises a ball pivot which is articulated in a thin-walled sliding shell. The end of the strut body and the sliding shell are jointly encapsulated with a plastic coating.

From EP 1 733 859 A1, a method and a device is known for producing a connection and force transmission element for suspension and steering mechanisms of motor vehicles by means of overmolding. The connecting element has a rod-shaped central part made of a material of high mechanical strength and an end part made of plastic material, which is overmolded on one end of the central part so that a one-piece connecting element is formed.

### SUMMARY

The present disclosure relates to a coupling rod for a chassis of a motor vehicle and to a method of producing such a coupling rod. The coupling rod for a chassis of a motor vehicle can be easy to manufacture and can have a low weight. A corresponding method allows such a coupling rod to be produced easily and efficiently.

A chassis of a motor vehicle is disclosed, comprising a connecting element which is produced from a fiber-reinforced plastic by a pultrusion process, the fiber-reinforced plastic comprising continuous fibers embedded in a matrix which extend in a longitudinal direction of the connecting element, the connecting element having a strut portion with a longitudinal axis and, at least at one end, a connecting portion which is deformed with respect to the strut portion; a joint element; and a carrier element connected to the connecting element and the joint element, which is made of plastic by overmolding, with an interlocking connection formed between the connecting portion of the connecting element and the carrier element.

An advantage of the coupling rod is that it is lightweight due to the use of fiber-reinforced plastic and is easy to manufacture using the pultrusion process. The formed connecting portion, which deviates from a continuous long form with a constant cross-section, can be produced using the pultrusion process. The formed connecting portion can be used to create a secure connection to the over-molded carrier element and the joint element accommodated therein, respectively.

At least one end of the coupling rod has a connecting portion that is deformed in relation to the strut portion, which includes the possibility that both ends may also have a deformed connecting portion. During overmolding with plastic, the joint element can be positioned with its joint axis as desired and thus connected to the rod element. The overmolded carrier element is used to connect the joint element to the rod element and to hold the joint element; in this respect, the carrier element can also be referred to as the joint holder. When two joint elements are used, they can be positioned at any angle to each other, i.e. between 0° and 180° in relation to the longitudinal axis of the coupling rod.

The joint element has a bearing part accommodated in the carrier element and a connecting part that can be connected to a chassis part. The design of the joint element is arbitrary and can be selected according to circumstances. For example, the coupling rod can have at least one joint element made of a metallic material, with a ball portion as the bearing part and a stud portion as the connecting part. The joint element can be designed with or without a ball shell and/or be embedded in the plastic joint holder. Alternatively or additionally, the coupling rod can have at least one joint element made of an elastic material. The elastic joint element can have an elastic bearing part and a rigid sleeve connected thereto as a connecting part. The elastic bearing part can be made of rubber, for example, and can be connected to the carrier element by overmolding or press-fitting. The sleeve can be made of metal, for example aluminum or steel, and can be inserted into the bearing part. Alternatively, the bearing part can be vulcanized onto the sleeve. According to a possible embodiment, the formed connecting portion has a smallest transverse extension in cross-section that is smaller than 0.5 times, in particular smaller than 0.75 times, the smallest diameter of the strut portion. A forming region is designed in particular in such a way that a form-fit connection is created in the axial direction and against twisting with respect to the overmolded carrier element. According to a possible embodiment, a cross-sectional area of the formed connecting portion can deviate from a cross-sectional area of the strut portion by less than 25%, in particular less than 10%. This results in a homogeneous structure of the continuous fibers over the entire length of the connecting element, which leads to a high load-bearing capacity and long service life.

According to an embodiment, the connecting element is designed as a hollow profile, at least in the strut portion, wherein a design as a solid profile is also possible. When manufactured as a hollow profile, the wall thickness can be greater than 2 mm and/or less than 4 mm. A connecting portion can be produced by radially pressing in the hollow profile so that a constriction is created. The pressing-in can be made such that the hollow profile is closed in this section, in particular by joining two opposing wall sections seen in cross-section. Closing the hollow profile in the connecting portion prevents plastic from entering the hollow space of the connecting element in an undesired manner when the joint element is injection-molded.

The matrix of the fiber-reinforced plastic can be a thermoset or a thermoplastic. Thermosets are tightly cross-linked polymer materials, with the material being solid after cross-linking. A thermoset can also be described as a hardened synthetic resin. Thermosets are usually formed as non-crosslinked pre-condensates from the dissolved, liquid or plastic state and then hardened. Crosslinking can take place simultaneously or after shaping. Thermosetting plastics from the group of vinyl ester resins, epoxy resins or unsaturated polyester resins or combinations thereof are preferably used for the matrix of the connecting element. The thermosets used can be selected so that they preferably harden at room temperature, i.e., without the addition of heat. Furthermore, the thermosets can be particularly fast-curing, i.e., achieve dimensional stability in less than 10 seconds when curing.

The plastic overmolding can be made from a thermoplastic. The continuous fibers can comprise glass fibers (GF) and/or carbon fibers (CF) and/or aramid fibers (AF) and/or natural fibers or combinations of the aforementioned fibers. The continuous fibers are arranged unidirectionally or quasi-isotropically along the connecting element and/or at least the strut portion. They can extend over the entire length from one end to the other end of the connecting element. The connecting element can have a fiber volume share of between 50% and 70% of the total volume in the strut portion. In the connecting portion adjoining the strut portion, the matrix proportion can be slightly reduced so that the fiber volume proportion here can be between 50% and 80%, for example.

The properties of the fiber-reinforced plastics can be adjusted as desired by means of the compounds and crosslinking substances used in the thermosets, as well as the reinforcing materials of the fibers (GF, CR, AF). Preferably, the fiber-reinforced plastic, in particular with a thermoset matrix, is designed such that the connecting element has a transverse tensile strength of at least 40 MPa, in particular at least 50 MPa. The effective modulus of elasticity of a fiber-reinforced plastic is defined in particular by the modulus of elasticity of the fibers, the modulus of elasticity of the matrix and the fiber volume fraction. According to the invention, the fiber-reinforced plastic made of thermoset material can be designed such that the effective modulus of elasticity in the fiber direction is greater than 35 GPa, in particular greater than 40 GPa.

According to a first embodiment, the connecting portion can be designed in such a way that it ends before the joint head. The formed connecting portion can have at least one cross-section-reducing indentation, which forms the interlocking connection with the overmolded carrier element. Several axially spaced indentations can also be provided, which can be axially offset from one another by 0.5 to 2 times the diameter of the strut portion, for example. Preferably, exactly two indentations are provided, an axially end-side indentation and an axially spaced-apart indentation, between which exactly one thickening is formed. When using a hollow profile, the end of the connecting portion can be closed in order to prevent plastic from penetrating when the associated joint element is molded on.

According to an alternative embodiment, the formed connecting portion can be designed in such a way that it extends as far as the bearing part and/or joint head when viewed from the side. The connecting portion of the connecting element can embrace the bearing part, respectively the ball portion of the joint head over an angular range of at least 90°, in particular at least 180° and/or up to 360°, around the joint axis. This can ensure that the connection region is reinforced.

The joint element can have a stud portion which is firmly connected to the ball portion, with a sealing bellows being provided which seals the stud portion relative to the molded-on carrier element. The bellows is fixed in a sealing manner with a first collar on the stud portion and with a second collar on the carrier element.

Further, a method for producing a coupling rod comprises producing an endless profile by means of pultrusion in a continuous process from endless fibers embedded in a plastic matrix, the endless profile being at least partially hardened, the endless profile being provided in second sections with a higher ductility and/or formability than in hardened first sections; forming the endless profile in the second sections so that formed regions are produced; hardening the second sections after the forming so that the endless profile is completely hardened; cutting the fully hardened endless profile into a connecting element comprising a strut portion and at least one formed connecting portion; providing a joint element comprising a bearing part and a connecting part; inserting and aligning the connecting element and the joint element in an injection mold, wherein a mold cavity is formed around the connecting portion of the connecting element; and injecting plastic into the mold cavity, wherein an interlocking connection is obtained between the carrier element thus formed and the connecting portion of the connecting element by curing of the injected plastic.

The method achieves the same advantages as described above in connection with the coupling rod according to the disclosure. It is to be understood that the features described with respect to the product can be transferred analogously to the method, and vice versa.

There are two possible process embodiments for creating the formed regions. According to a first option, which applies in particular to a thermoset matrix, the continuous profile is hardened to such an extent that it is already dimensionally stable, but still ductile enough to be formed in sections by an external force. After forming, the continuous profile is then fully hardened, e.g. with or without the addition of heat. According to a second option, which applies in particular to a thermoplastic matrix, the endless profile is first hardened completely and then the second sections are softened again by heating so that they can be formed. After the second sections have been formed, they are then cooled again and thus hardened so that the endless profile is fully hardened.

According to a possible method, the connecting portion of the connecting element can be subjected to a structuring surface treatment before overmolding. This increases the surface area, resulting in an improved joining connection to the over-molded plastic. The surface treatment can be achieved, for example, by mechanically incorporating a micro-serration. This can be done in particular during the forming process using a suitable shaping structure of the forming tool. Alternatively, the surface can also be processed by partially removing the upper plastic layer, for example by laser processing. Preferably, at least 50% of the surface to be overmolded is treated to create a structure, in particular at least 75%. The structure produced can have a roughness of more than 100 micrometers and less than 1 mm, for example. As an alternative or in addition to the surface treatment that provides the structure, the connecting portion can be provided with an adhesion promoter. In addition to the form-fit connection, a material-fit connection is also created, which results in a particularly reliable connection.

If a ball joint is used, a bearing shell for the joint ball can also be optionally injected or overmolded during the overmolding process.

### BRIEF SUMMARY OF THE DRAWINGS

Example embodiments are explained below with reference to the drawing figures. Herein:

FIG. 1A shows a coupling rod in a first embodiment in side view, partially cut;

FIG. 1B shows a first end of the coupling rod from FIG. 1A as a detail in enlarged view, without seal;

FIG. 1C shows a second end of the coupling rod from FIG. 1A as a detail in enlarged longitudinal section, without seal;

FIG. 1D shows the connecting element of the coupling rod from FIG. 1A in perspective view, partially cut;

FIG. 1E shows an enlarged view of the end of the connecting element from FIG. 1D;

FIG. 2 shows the end of a coupling rod in a slightly modified embodiment compared to the embodiment shown in FIG. 1;

FIG. 3A shows a coupling rod a further embodiment in side view, partially cut;

FIG. 3B shows the connecting element of the coupling rod from FIG. 3A in perspective view, partially cut;

FIG. 3C shows an enlarged view of the end of the connecting element from FIG. 3B;

FIG. 4 shows a coupling rod in a further embodiment in longitudinal section, partly in exploded view; and

FIG. 5 shows a coupling rod in a further embodiment, in a partially cut view.

### DESCRIPTION

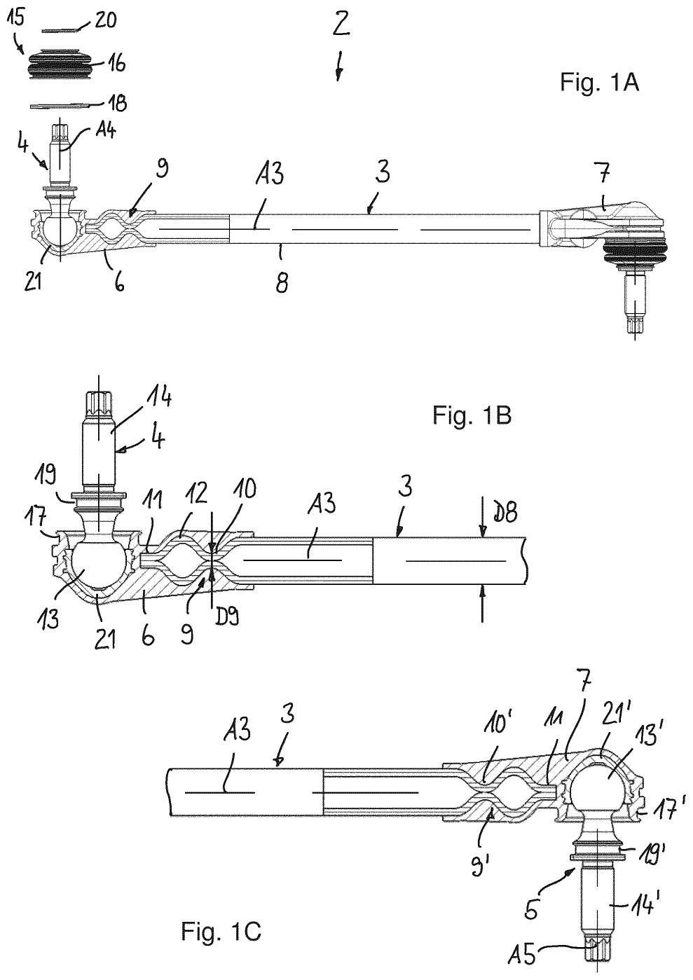

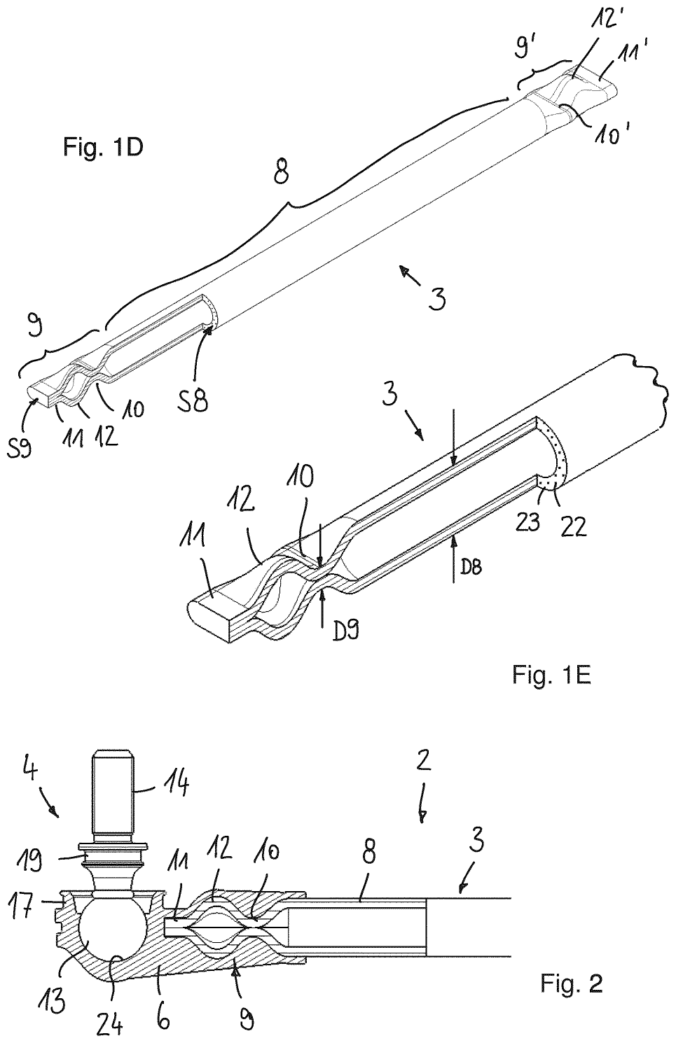

FIGS. 1A to 1E, which are collectively also referred to as FIG. 1 and are described together below, show a coupling rod 2 in a first embodiment. The coupling rod 2 can be used, for example, for a chassis of a motor vehicle in order to connect an axle stabilizer to the chassis.

The coupling rod 2 comprises a connecting element 3 made of a fiber-reinforced plastic, to each end of which a joint element 4, 5 is attached by means of an over-molded carrier element 6, 7.

The connecting element 3 is made from continuous fiber-reinforced plastic using a pultrusion process. The connecting element comprises continuous fibers 22 embedded in a matrix 23, which extend along the length of the connecting element. During pultrusion, the profile of the connecting element 3 is produced in a continuous process by selectively combining fiber reinforcements and resin systems. The connecting element 3 is designed as a hollow profile, without being limited thereto, and comprises a strut portion 8 and formed connecting portions 9, 9′ at both ends. The wall thickness of the hollow profile can be selected according to the technical specifications and can, for example, be between 2 mm and 4 mm in the strut portion.

In the present embodiment, the formed connecting portions 9, 9′ are each produced by pressing in the hollow profile at several axially spaced points. Viewed in longitudinal section, this produces a double-wave-shaped profile with tapered regions 10, 11 and a widened area 12 therebetween. The formations can be produced in a partially hardened state during the pultrusion process, i.e., before these formed regions are fully hardened. The sequence of tapered respectively flattened regions 10, 11 and the widened profile regions 12 therebetween creates a secure form-fit connection to the carrier element 6, 7, both in the axial direction and against twisting.

The matrix 23 of the fiber-reinforced plastic can be a thermoset or a thermoplastic. The continuous fibers 22 may comprise glass fibers (GF) and/or carbon fibers (CF) and/or aramid fibers (AF) and/or natural fibers or combinations of said fibers. The continuous fibers are preferably arranged unidirectionally or quasi-isotropically along the connecting element 3 and/or the strut portion 8. In the strut portion 8, the fiber volume proportion of the total volume of fibers 22 and matrix 23 is between 50% and 70%. In the connecting portion, the matrix proportion may be somewhat reduced due to the forming, so that a fiber volume proportion of between 50% and 80% may result here, for example. The cross-sectional area S9 of the connecting portion 9, 9′ can substantially correspond to the cross-sectional area S8 of the strut portion 8, wherein deviations of less than 25%, in particular less than 10%, are possible.

The connecting element 3 can be made of a matrix of thermoset with continuous fibers 22 embedded therein in such a way that it has a transverse tensile strength of at least 40 MPa. The effective modulus of elasticity of the connecting element 3 in the fiber direction is in particular greater than 35 GPa.

In the embodiment shown in FIG. 1, the connecting portion 9, 9′ ends before the joint element 4, 5, wherein the interlocking connection between the aforementioned components is formed by the overmolded carrier element 6, 7. In the present embodiment, the joint elements 4, 5 are designed in the form of ball studs, which are each made of a metallic material and have a ball portion as the bearing part 13 and a stud portion as the connecting part 14. In the present embodiment, a spherical shell 21 is also injected into the respective carrier element 6, 7, in which the ball portion 13 is pivotably mounted.

The joint element 4, 5 is attached to the connecting element 3 by overmolding with plastic. In the hardened state, the overmolded plastic forms the carrier element 6, 7, which is form-fittingly connected to the connecting element 3 on the one hand and forms a receptacle for an associated joint element on the other. A thermoplastic material can be used for the plastic overmolding. During overmolding, the respective joint element 4, 5 is positioned with its joint axis A4, A5 as desired and thus connected to the connecting element 3. The two joint elements 4, 5 can be positioned at any angle to one another, wherein the two joint axes A4, A5 can form an angle of between 0° and 180° with one another when viewed axially to the longitudinal axis of the coupling rod.

The joint area can be sealed by means of a seal 15, 15′. At the first end in FIG. 1A, the seal 15 is shown in exploded view, and at the second end the seal 15′ is shown mounted. The seal 15, 15′ comprises a sealing bellows 16, 16′, which is mounted with a first collar on an annular groove 17 of the carrier element 6, 7 and is sealingly secured by means of a retaining ring 18, 18′, and with a second collar engages in an annular groove 19 of the joint element 4, 5 and is sealingly secured by means of a retaining ring 20, 20′.

A method of producing a coupling rod 2 can comprise the following steps: an endless profile is produced by pultrusion in a continuous process from endless fibers 22 embedded in a plastic matrix 23. The endless profile is hardened, wherein at least sections are still formable or are made formable again, which later form the connecting portions 9. After partial hardening, the connecting portions 9 are formed-in into the endless profile by a forming operation. The continuous profile is fully hardened and then cut to length to form a connecting element 3 with strut portion 8 and connecting portion 9. The connecting element 3 and a prefabricated joint element 4, 5 are inserted into an injection mold and aligned with each other in the desired position. Plastic is injected into the mold cavity thus formed, which then hardens to form the carrier element 7. In this way, a positive connection is formed between the carrier element 7 and the connecting portion 9 of the connecting element 3.

FIG. 2 shows the end portion of a coupling rod in a modified embodiment in which no spherical shell is provided in the carrier element 6, 7. Instead, the ball portion 13 is pivotably mounted directly in a spherical inner surface 24 of the carrier element 6. Otherwise, the present embodiment according to FIG. 2 corresponds to that shown in FIG. 1, to the description of which reference is made in this respect by way of abbreviation.

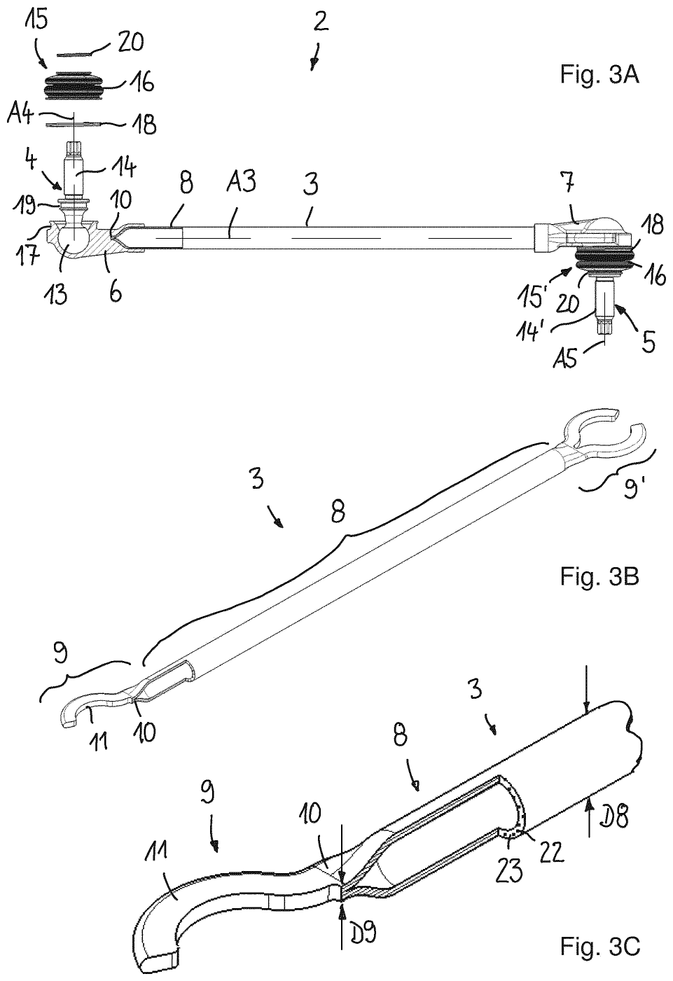

FIGS. 3A to 3C, together also referred to as FIG. 3, show a coupling rod in a further embodiment. This largely corresponds to the embodiment shown in FIG. 1, to the description of which reference is made in this respect. The same and/or corresponding details are provided with the same reference signs as in FIG. 1.

A special feature of the embodiment according to FIG. 3 is the design of the connecting portions 9, 9′ at the ends of the connecting element 3, which are shaped in a C-shape so that they engage around the ball portion of the respective joint element and form a reinforcement therefor. The connecting portions 9, 9′ can be designed in such a way that they surround the ball portion of the joint head over an angular range of at least 90°, in particular at least 180°, around the joint axis A4, A5. This can ensure effective reinforcement of the connection area and good force support from the joint element 4, 5 into the connecting element 3.

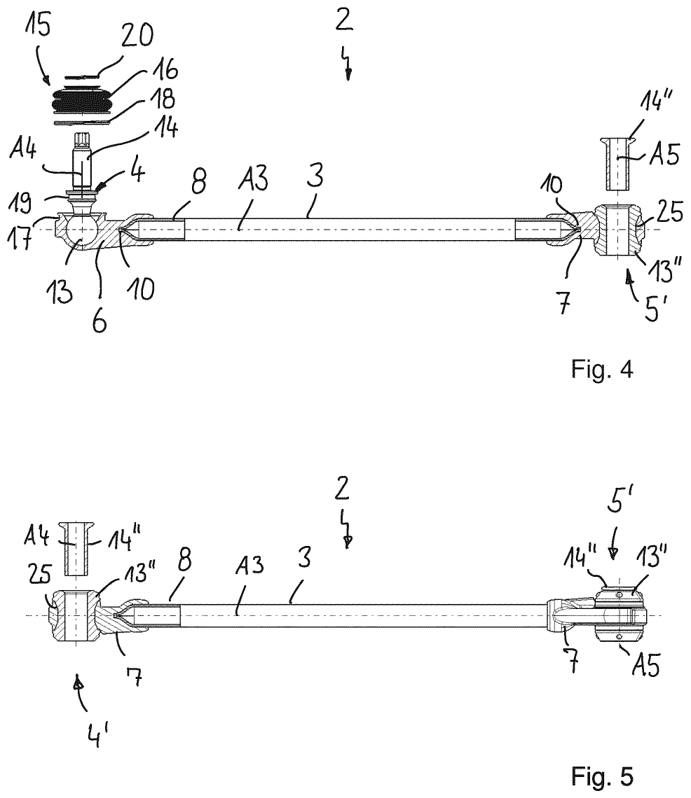

FIG. 4 shows a coupling rod in a further embodiment. This largely corresponds to the embodiment shown in FIG. 3, to the description of which reference is made in this respect. The same or corresponding details are provided with the same reference signs as in the figures above.

A special feature of the embodiment shown in FIG. 4 is that the two joint elements 4, 5′ are designed differently. One joint element 4, shown here on the left-hand side, is designed as a ball joint, as shown in the embodiment in FIG. 3. The other joint element 5′, shown here on the right-hand side, is designed as an elastic joint. The elastic joint element 5′ comprises an elastic bearing part 13″ and a connecting part 14″ connected thereto in the form of a rigid sleeve. The elastic bearing part 13″ can be made of rubber, for example, and can be connected to the carrier element 7 by overmolding or press-fitting. The elastic bearing part 13″ can have a circumferential, in particular concave recess 25, which is embraced by the ring portion of the carrier element 7. The connecting element 3 can be designed with two C-shaped connecting portions 9, 9′, as in the embodiment shown in FIG. 3. In this case, the connecting portion associated with the elastic joint 5′ is embedded in the carrier element 7 and largely surrounds the elastic bearing part 13″. The sleeve can be made of metal, for example aluminum or steel. The sleeve can be inserted into the bearing part 13″. Alternatively, the bearing part 13″ can be vulcanized onto the sleeve.

FIG. 5 shows a coupling rod in a further embodiment. This largely corresponds to the embodiment shown in FIG. 4, to the description of which reference is made in this respect. The same and/or corresponding details are provided with the same reference signs as in the figures above.

As shown in FIG. 5, the two joint elements 4′, 5′ are designed as elastic joints as in FIG. 4, right-hand side. Both joints have the same design, wherein the left-hand side is shown in section, with sleeve in exploded view, while the right-hand side is shown in side view.

### LIST OF REFERENCE SIGNS

2 coupling rod
3 connecting element
4, 4′ joint element
5,5′ joint element
6 carrier element
7 carrier element
8 strut portion
9, 9′ connecting portion
10, 10′ region
11, 11′ region
12, 12′ region
13, 13′, 13″ bearing part
14, 14′, 14″ connecting part
15, 15′ sealing
16, 16′ sealing bellows
17 annular groove
18, 18′ retaining ring
19 annular groove
20, 20′ retaining ring
21,21′ spherical shell
22 fibers
23 matrix
24 inner face
25 recess
A axis
D diameter
S face

1.-16. (canceled)

17. A coupling rod comprising:
a connecting element produced from a fiber-reinforced plastic by a pultrusion process, the fiber-reinforced plastic including continuous fibers embedded in a matrix and extending in a longitudinal direction of the connecting element, the connecting element having a strut portion with a longitudinal axis and, at least at one end, a connecting portion;
a joint element; and
a carrier element connected to the connecting element and the joint element is produced from plastic by overmolding;
wherein the matrix of the fiber-reinforced plastic of the connecting element is a thermoset, and the connecting portion of the connecting element produced by pultrusion is formed relative to the strut portion, with an interlocking connection formed between the formed connecting portion and the carrier element by the overmolded carrier element.

18. The coupling rod of claim 17,
wherein the matrix of the fiber-reinforced plastic is selected from the group consisting of vinyl ester resins, epoxy resins, or polyester resins.

19. The coupling rod of claim 17,
wherein the connecting element is formed as a hollow profile at least in the strut portion, with a wall thickness of the hollow profile being greater than 2 millimeters (mm) and less than 4 mm.

20. The coupling rod of claim 17,
wherein the continuous fibers are arranged unidirectionally along the connecting element.

21. The coupling rod of claim 17,
wherein the carrier element is made of a thermoplastic material.

22. The coupling rod of claim 17,
wherein a material-locking connection is provided between the carrier element and the connecting portion of the connecting element, which is produced by an adhesion promoter applied to the connecting portion before overmolding, and/or the connecting portion is provided with a surface structure before overmolding.

23. The coupling rod of claim 17,
wherein the connecting portion comprises a cross-section-reducing first indentation at an axial end of the connecting element and, axially offset thereto, a cross-section-reducing second indentation;
wherein the first indentation forms a tight closure of the connecting element; and
wherein a smallest cross-sectional extension in the region of the first and second indentations is respectively smaller than 0.5 times a smallest diameter of the strut portion.

24. The coupling rod of claim 17,
wherein the joint element has a ball portion and a stud portion, the connecting portion provided such that it embraces the ball portion over an angular range of at least 90° about the joint axis, or
that the joint element has an elastic bearing part and a connecting part, the connecting portion provided such that it embraces the elastic bearing part over an angular range of at least 90° about the joint axis.

25. The coupling rod of claim 17,
wherein a total cross-sectional area of the connecting portion deviates from a total cross-sectional area of the strut portion by less than 25%.

26. The coupling rod of claim 17,
wherein the connecting element in the strut portion has a fiber volume fraction of the total volume which is between 50% and 70%;
wherein the fiber volume fraction of the connecting element in the connecting portion is equal to or greater than the fiber volume fraction in the strut portion.

27. The coupling rod of claim 17,
wherein the connecting element is made of thermoset material with continuous fibers embedded therein in such a way that the connecting element has a transverse tensile strength of at least 40 MPa; and,
wherein an effective modulus of elasticity of the connecting element in the fiber direction is greater than 35 GPa.

28. The coupling rod of claim 17,
wherein a surface of the connecting portion has a higher roughness than a surface of the strut portion.

29. The coupling rod of claim 17,
wherein the joint element is sealed by a sealing bellows, with a first collar of the sealing bellows connected to the carrier element, and a second collar of the sealing bellows connected to the stud portion of the joint element.

30. The coupling rod of claim 17, produced by a method comprising:
producing an endless profile by pultrusion in a continuous process from endless fibers embedded in a plastic matrix, the plastic matrix including a thermoset, and the endless profile being hardened to such an extent that it has a higher ductility at least in sections, so that these are formable;
forming the endless profile in the ductile sections so that formed regions are created;
hardening the formed sections after forming so that the endless profile is completely hardened;
cutting the completely hardened endless profile into a connecting element, which has a strut portion and at least one formed connecting portion;
providing a joint element;
inserting and aligning the connecting element and the joint element in an injection mold, wherein a mold cavity is formed around the connecting portion of the connecting element; and
injecting plastic into the mold cavity;
wherein an interlocking connection is formed between the carrier element thus formed and the connecting portion of the connecting element by curing the injected plastic.

31. The coupling rod of claim 30,
wherein the pultrusion is carried out with partial hardening of the continuous profile, forming of the ductile sections, and then complete hardening.

32. The coupling rod of claim 30,
wherein the connecting portion of the connecting element is subjected to at least one of a structure-giving surface treatment or being provided with an adhesion promoter prior to overmolding.
